(19) United States
(12) Patent Application Publication
(10) Pub. No.: US 2008/0304819 A1
(43) Pub. Date: Dec. 11, 2008

(54) THIN ACTIVE CAMERA COVER FOR AN ELECTRONIC DEVICE

(75) Inventor: William H. Tolbert, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/759,967

(22) Filed: Jun. 8, 2007

(51) Int. Cl. G03B 17/56

(52) U.S. Cl. 396/448

(57) ABSTRACT

An electronic device includes camera circuitry for carrying out a camera related operation, the camera circuitry including a camera lens that is at least partially covered by a visual indicator element. The visual indicator element is substantially opaque when the camera circuitry is in a first state (e.g., an “off” state) and the visual indicator element is substantially transparent when the camera circuitry is in a second state (e.g., an “on” state). Optionally, an audible and/or visual indication mechanism may also be output to the user when the camera circuitry is activated.

### TECHNICAL FIELD OF THE INVENTION

The present invention relates generally to portable electronic devices such as mobile phones, and more particularly to portable electronic devices having an auxiliary camera function.

### DESCRIPTION OF THE RELATED ART

Portable electronic devices such as mobile telephones have been popular for years and yet only continue to increase in popularity. Traditionally, mobile telephones had been used strictly for conventional voice communications. However, as technology has developed mobile telephones are now capable not only of conventional voice communications, but also are capable of data communications, video transfer, media reproduction, commercial radio reception, etc. More and more, a user having a single electronic device such as a mobile telephone is able to perform a variety of different functions.

Many mobile telephones today include a camera function for taking pictures and/or videos. Mobile telephones that include a high-end camera commonly include an active cover over the camera lens. The active cover serves to protect the camera lens from damage, dust and scratches. The active cover may also be used to start the camera function of the mobile telephone if an electrical switch is incorporated. The active cover also provides the user and/or subject a visual indication that the camera function is in an “on” state or “off” state. One drawback with active camera covers is that active camera covers increase the size and cost of the mobile telephone. The desire for low cost and/or small mobile telephones often eliminates the viability of an active cover in favor of a simple cover lens mounted over the camera lens module. A simple cover lens generally provides some scratch and dust protection. One drawback with a simple cover lens is the user is not provided an easily perceived indication as to whether the camera function is an “on” state or an “off”.

### SUMMARY

In view of the aforementioned shortcomings, there is a need in the art for a mobile phone or other electronic device that provides protection from dust and scratch protection to a camera lens, as well as a visual indication to the user of the state of the camera function without sacrificing size and/or convenience to the user. In addition, there is also a need in the art to provide a mechanism that substantially conceals the camera lens or substantially renders the camera lens undetectable when the camera is not in use for security purposes and/or other aesthetic purposes.

According to one aspect of the invention, an electronic device is provided that includes: a microcontroller; camera circuitry for carrying out a camera related operation operatively coupled to the microcontroller; a camera lens operatively coupled to the camera circuitry for focusing the camera lens; and a visual indicator element that covers at least a portion of the camera lens, wherein the visual indicator element is substantially opaque when the camera circuitry is in a first state and the visual indicator element is substantially transparent when the camera circuitry is in a second state.

According to another aspect of the invention, the visual indicator element is operatively coupled to the camera circuitry and/or the microcontroller.

According to another aspect of the invention, the visual indicator element is in the first state when a first electrical current is applied to the visual indicator element.

According to another aspect of the invention, the visual indicator element is in the second state when a second electrical current is applied to the visual indicator element.

According to another aspect of the invention, further including an operator input operatively coupled to the camera circuitry and/or the microcontroller for changing the camera circuitry from the first state to the second state.

According to another aspect of the invention, further including an operator input operatively coupled to at least the camera circuitry for changing the camera from the second state to the first state.

According to another aspect of the invention, the first state corresponds to the camera circuitry being in a deactivated state.

According to another aspect of the invention, the second state corresponds to the camera circuitry being in an activated state.

According to another aspect of the invention, further including circuitry operatively coupled to the microcontroller for carrying out an operation unrelated to camera operation.

According to another aspect of the invention, the operation unrelated to camera operation includes placing and/or receiving a telephone call to and/or from a mobile telecommunication network.

According to another aspect of the invention, an audible indication is selectively output from a speaker coupled to the microcontroller when the visual indication element changes from the first state to the second state and/or from the second state to the first state.

According to another aspect of the invention, a user indication signal is selectively output from a flash coupled to the microcontroller when the visual indication element changes from the first state to the second state and/or from the second state to the first state.

According to another aspect of the invention, a user indication signal is selectively output from a flash coupled to the microcontroller and an audible indication is selectively output from a speaker coupled to the microcontroller when the visible indication element changes from the first state to the second state and/or from the second state to the first state.

According to another aspect of the invention, including a protective layer over at least a portion of the visual indication element.

According to another aspect of the invention, wherein the protective layer is substantially transparent.

Another aspect of the invention relates to providing an electronic device including: a microcontroller; camera circuitry for carrying out a camera related operation operatively coupled to the microcontroller; a camera lens operatively coupled to the camera circuitry for focusing the camera lens; and an electrochromic element that covers at least a portion of the camera lens, wherein the electrochromic element is substantially opaque when the camera circuitry is in a first state and the electrochromic element is substantially transparent when the camera circuitry is in a second state.

According to another aspect of the invention, wherein an audible indication is selectively output from a speaker coupled to the microcontroller when the electrochromic element changes from the first state to the second state and/or from the second state to the first state.

According to another aspect of the invention, wherein a user indication signal is selectively output from a flash coupled to the microcontroller when the electrochromic element changes from the first state to the second state and/or from the second state to the first state.

According to another aspect of the invention, including a substantially transparent protective layer over at least a portion of the electrochromic element.

Another aspect of the invention relates to an electronic device, including: a microcontroller; camera circuitry for carrying out a camera related operation operatively coupled to the microcontroller; a camera lens operatively coupled to the camera circuitry for focusing the camera lens, wherein the camera lens is mounted on a housing of the electronic device; and a visual indicator element that covers at least a portion of the camera lens, wherein the visual indicator element substantially conceals the camera lens when the camera circuitry is in a first state and the camera lens is substantially transparent when the camera circuitry is in a second state.

According to another aspect of the invention, the visual indicator element substantially matches a color of the housing when the camera circuitry is in the first state.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a front perspective view of an electronic device in an exemplary embodiment of the present invention.

FIG. 2 is a rear perspective view of the electronic device of FIG. 1 in accordance with the exemplary embodiment of the present invention.

FIG. 3A is a front view of a camera lens in an exemplary embodiment of the present invention in an “off” state.

FIG. 3B is a side view of a camera lens in an exemplary embodiment of the present invention in an “off” state.

FIG. 3C is a front view of a camera lens of another exemplary embodiment of the present invention in an “off” state.

FIG. 4A is a front view of a camera lens in an exemplary embodiment of the present invention in an “on” state.

FIG. 4B is a side view of a camera lens in an exemplary embodiment of the present invention in an “on” state.

FIG. 5 is a schematic block diagram of the electronic device of FIGS. 1 and 2 in accordance with the exemplary embodiment of the present invention.

FIG. 6 is a flowchart representing operation of camera lens cover control in accordance with one embodiment of the present invention.

### DETAILED DESCRIPTION OF EMBODIMENTS

The present invention will now be described with reference to the figures, wherein like reference numerals are used to refer to like elements throughout.

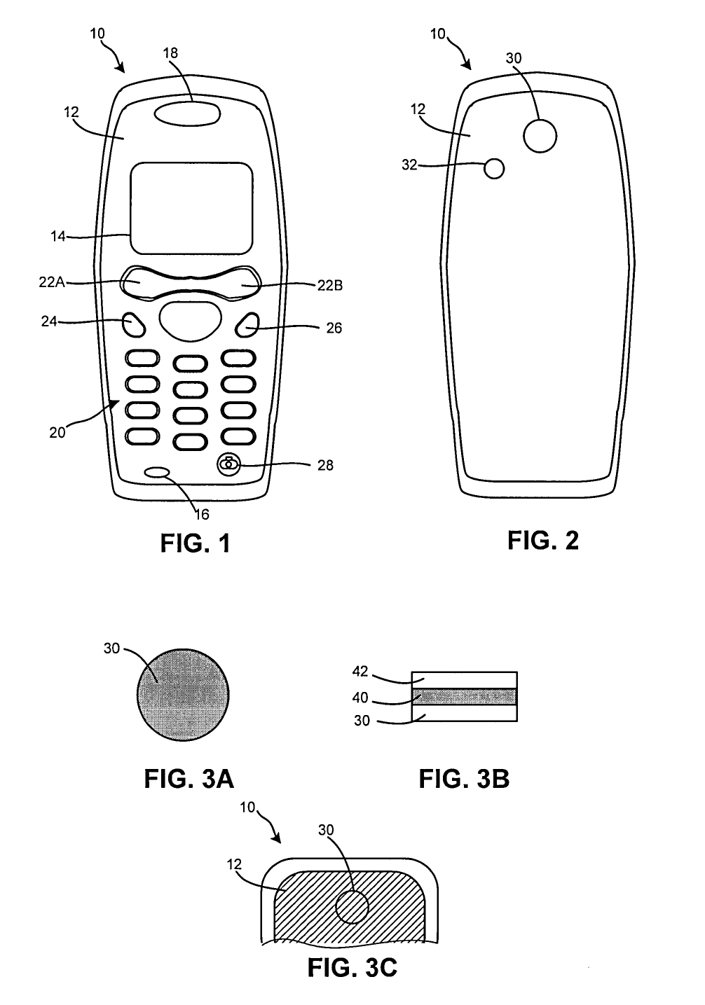

Referring initially to FIGS. 1 and 2, an electronic device 10 is shown in accordance with an exemplary embodiment of the present invention. In the exemplary embodiment, the electronic device 10 is a mobile phone for carrying out mobile communications including voice communications, etc. In addition to operating as a mobile phone, the electronic device 10 also may function as a camera for taking photographs and/or video clips. While the present invention is described herein in the context of the electronic device 10 being a mobile phone, it will be appreciated that the electronic device 10 may be any type of electronic device having an auxiliary camera function (e.g., a personal digital assistant (PDA), personal media player, etc.). The particular type of electronic device is not germane to the present invention in its broadest sense.

As is shown in FIG. 1, the exemplary embodiment of the mobile telephone 10 includes a housing 12 having opening for receiving a liquid crystal display 14. The display 14 serves as a graphical user interface (GUI). The display 14 provides a display of various types of information as is conventional. For example, the display 14 may display the operational status of the mobile telephone 10, contact information, menu information, text, graphics, images, videos, etc. When the mobile telephone 10 is utilized as a camera as described herein, the display 14 may function as an electronic viewfinder to aid the user when taking a photograph, a video clip and/or a viewer for displaying saved photographs and/or video clips. In addition, in the case where the display 14 is a touch sensitive display, the display 14 may serve as an input device to allow the user to input data, menu selections, etc.

The mobile telephone 10 further includes a microphone 16 and a speaker 18. As is conventional, the microphone 16 and speaker 18 allow a user to carry out conventional voice communications by placing the mobile telephone 10 adjacent the user's ear and mouth. In addition, the mobile telephone 10 includes a keypad 20 having an assortment of keys. The keypad 20 facilitates user input and operation of the mobile telephone 10 as is conventional. For example, the keypad 20 may include keys for navigating the menus displayed on the display 14, selecting predefined functions such as camera operation, initiating or terminating a call, etc.

The mobile telephone 10 also may include other keys or buttons useful in the operation of the mobile telephone 10. For example, the mobile telephone 10 may include volume keys 22a and 22b mounted to the housing 12 that allow the volume of the speaker 18 to be adjusted during use of the mobile telephone 10 as a telephone or media player. In addition, the mobile telephone 10 may include a button 24 that allows a user to answer or “pick up” an incoming call simply by pressing the button 24. Likewise, the mobile telephone 10 may include a button 26 that allows a user to “hang up” or otherwise terminate a completed call and/or application simply by pressing the button 26.

In addition, the mobile telephone 10 may further include a button 28 to allow the user to initiate camera circuitry associated with the mobile telephone 10. By simply pressing the button 28, the camera circuitry may be initiated. One of ordinary skill in the art will readily appreciate that other mechanisms (e.g., selecting an application from a menu displayed on the display, selecting a different button, etc.) may be used to initiate the camera circuitry.

FIG. 2 illustrates the rear of the housing 12 of the mobile telephone 10. As is shown, the rear of the housing 12 includes a camera lens 30 and a flash element 32. As discussed in more detail below, the camera lens 30 is at least partially covered by a visual indicator element that covers at least a portion of the camera lens 32. The visual indicator element is substantially opaque when the camera circuitry is in a first state (e.g., an “off” state) and the visual indicator element is substantially transparent when the camera circuitry is in a second state (e.g., an “on” state). In another embodiment, the visual indicator is substantially the same color as the housing of the mobile telephone when in the opaque state in order to substantially conceal the camera lens and/or the camera function. The flash element 32 generally provides an additional light source under low lighting conditions.

Referring to FIGS. 3A, 3B, and 3C camera lens 30 is illustrated having a visual indicator element 40 and a protective cover 42 covering at least a portion of the camera lens 30. The visual indicator element 40 may be used to control the amount of light entering the cover lens 30. As shown in FIGS. 3A and 3B, the visual indicator element 40 is in a substantially opaque state, which prohibits substantially all light from entering the cover lens 30. Such a state may correspond to the camera function being in an “off” state.

In one embodiment, illustrated in FIG. 3C, the visual indicator element 40 and/or the protective cover 42 in conjunction with the visual indicator element 40 are selected to substantially conceal the camera lens 30 from others. Accordingly, the visual indicator element 40 and/or the protective cover 42 in conjunction with the visual indicator element 40 may chosen and/or otherwise designed to substantially match the color and/or finish of the area of the housing 12 that the camera lens 40 is mounted. Thus, when the camera function is an “off” state, the camera lens 40 is substantially concealed to viewers of the mobile telephone 10. There are a wide variety of reasons to include such functionality in a mobile telephone 10. For example, it may be desirable to conceal the camera lens from third parties so that it may be less likely that the mobile telephone 10 may be stolen, for aesthetic purposes, etc.

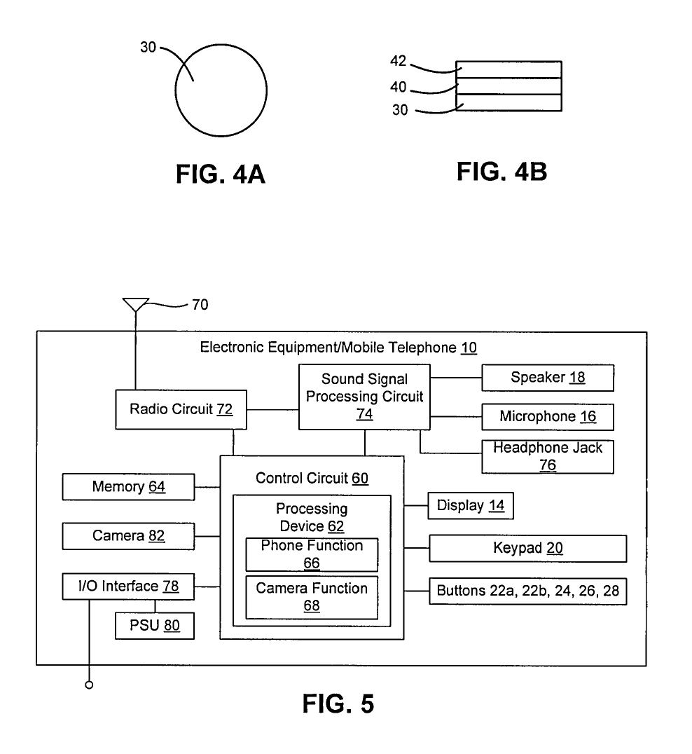

Referring to FIGS. 4A and 4B, the visual indicator element 40 is illustrated in a substantially transparent state. Such a state may correspond to the camera circuitry being in “active” or “on” state. In this state, environmental light (as well as light emitted from flash element 32 may enter the cover lens.

The visual indicator element 40 may be made of any material and/or comprise any suitable technology. For example, the visual indicator element 40 may be an electro-chromic coating applied on and/or above the cover lens 30. In addition, the visual indicator element 40 may be comprised of suspended particle devices, liquid crystal display technology and/or other display technologies. The visual indicator element 40 may be any technology that utilizes an electrical current to change from high transmittance state to a low transmittance or highly reflective state and vice versa. The visual indicator element 40 gives the appearance that camera is closed (e.g., like a closed iris or door), when the visual indicator element 40 is in a substantially opaque state. The visual indicator element 40 gives the camera an appearance that it is “on” (e.g., like an opened iris or door), when the visual indictor element 40 is in a substantially transparent state. In addition, the visual indicator element 40 functions as a thin active camera cover, which protects the camera lens 30 from being scratched during normal operation.

The visual indicator element 40 may be triggered by any desirable mechanism. For example, the user may press button 28 to activate the camera circuitry. As stated above, when the camera is in an “off” state, the visual indicator element 40 is substantially opaque. After the user presses button 28, the camera circuitry is activated and the visual indicator 40 changes from the first state to the second state as described below.

The protective cover 42 may be made of any suitable material (e.g., glass, plastic, etc.). The protective cover 42 generally protects the camera lens from being scratched during transport and/or during normal operation. The protective cover 42 is optional and may be incorporated in the visual indicator element 40. The visual indicator element 40 may also include and/or be made of a material that also provides protection from scratches, dust and dirt in addition to its ability to change from one state to another state.

In addition, to the visual indicator element 40, it may desirable to provide the user with an audible indication is selectively output from the speaker 18 when the camera circuitry is activated and/or deactivated. Likewise, a user indication signal may also be selectively output from the flash element 32 when the visual indication element changes from the first state to the second state and/or from the second state to the first state. One of ordinary skill in the art will appreciate that either one of the audible indication or user indication signal and/or both may be used to enhance the user experience to indicate a switch and/or change from one camera state to another.

FIG. 5 represents a functional block diagram of the mobile telephone 10 in accordance with the present invention. The construction of the mobile telephone 10 is generally conventional with the exception visual indication element 40 and related functions and/or control capabilities described herein. Such capabilities are implemented in hardware and software within the mobile telephone 10. However, it will be apparent to those having ordinary skill in the art that such operation can be carried out via primarily software, hardware, firmware, or combinations thereof, without departing from the scope of the invention.

The mobile telephone 10 includes a primary control circuit 60 that is configured to carry out overall control of the functions and operations of the mobile telephone 10. The control circuit 60 may include a CPU, microcontroller, or microprocessor, etc., collectively referred to herein simply as a CPU 62. The CPU 62 executes code stored in memory (not shown) within the control circuit 60, and/or in a separate memory 64 in order to carry out conventional operation of the mobile phone functions 66 within the mobile telephone 10. In addition, the CPU 62 executes code similarly stored in memory to carry out the camera functions 68 described herein.

Continuing to refer to FIG. 5, the mobile telephone 10 includes an antenna 70 coupled to a radio circuit 72. The radio circuit 72 includes a radio frequency transmitter and receiver for transmitting and receiving signals via the antenna 70 as is conventional. The mobile telephone 10 further includes a sound processing circuit 74 that processes the audio signal transmitted by/received from the radio circuit 72. In addition, the sound processing circuit 74 serves to process an audio signal provided by the control circuit 60 during playback of media files, for example. Also coupled to the sound processing circuit 74 are the aforementioned microphone 16 and speaker 18, and a headset jack 76, for example. The radio circuit 72 and sound processing circuit 74 are each coupled to the control circuit 60 that carries out overall operational control.

The mobile telephone 10 also includes the aforementioned display 14, keypad 20, buttons 22a and 22b, buttons 24, 26 and 28 coupled to the control circuit 60. The mobile telephone 10 further includes an I/O interface 78. The I/O interface 78 may be in the form of any one of many typical mobile phone I/O interfaces, such as a multi-element connector at the base of the mobile telephone 10. As is typical, the I/O interface 78 may be used to couple the mobile telephone 10 to a battery charger to charge a power supply unit (e.g., battery) 80 within the mobile telephone 10. Further, the I/O interface 78 may serve to connect the mobile telephone 10 to a personal computer or other device via a data cable, etc., in order to download photographs or perform various other operations. As another alternative, the I/O interface 78 may serve to connect the mobile telephone 10 to a docking station including an audio amplifier, speakers and/or video display to allow for enhanced viewing/listening of the media objects as part of a media player function.

The mobile telephone 10 includes a variety of camera hardware 82 to carry out aspects of the present invention. The camera hardware 82 include the camera lens 30, the visual indication element 40, the protective layer 42, as well as a charge-coupled device (CCD) array or other image capture device (not shown) and an image processing circuit, for example. The camera lens 30 serves to image an object(s) to be photographed onto the CCD array. Captured images received by the CCD 80 are input to an image processing circuit, which processes of the images under the control of the camera functions 68 so that photographs taken during camera operation are processed and stored in memory 64, for example.

The particular operating mode of the mobile telephone 10 is controlled by user selection via the keypad 20, menu selections via the display 14, etc., as is conventional. Upon being configured for operation of the mobile telephone 10 as a phone, the user may press the button 24 in order to pick up an incoming call, for example. The button 24 provides an input control signal to the mobile telephone functions 66, which interpret the control signal as a request to pick up the incoming call.

When wishing to take a picture with the mobile telephone 10 operating as a camera, a user presses button 28 or another suitable mechanism to initiate the camera circuitry 82 and/or camera functions 68. The control circuit 60 processes the signal generated from the user pressing button 28. The control circuit 60 supplies an electrical current to the visual indication element 40, which causes the visual indication element 40 to change from a first state (e.g., a substantially opaque state and/or a concealed state) to a second state (e.g., a substantially transparent state). The user is then able to take a photograph and/or video clip in a conventional manner. In this particular example, the image received by the CCD sensor may be provided to the display 14 via the camera functions 68 so as to function as an electronic viewfinder.

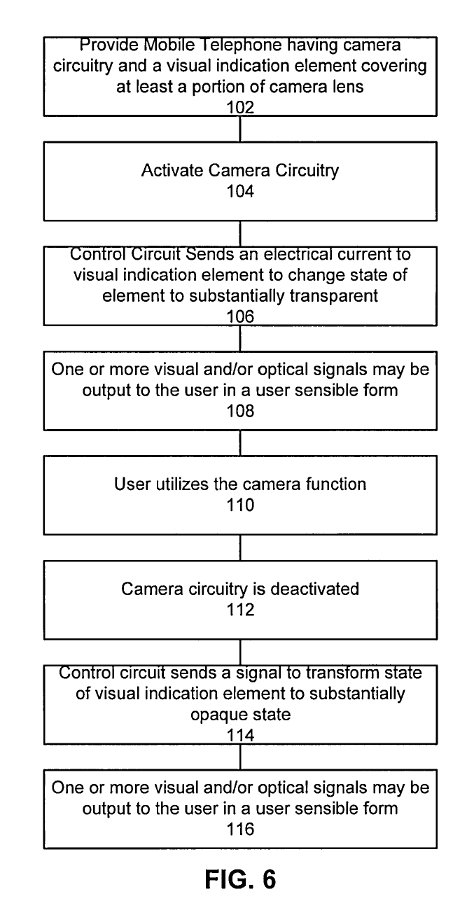

FIG. 6 is a flowchart describing an exemplary method 100 of operation of the present invention in relevant part. At step 102, a mobile telephone 10 is provided having camera circuitry and a visual indication element 40 covering at least a portion of the camera lens 30. At step 104, a user activates the camera circuitry of the mobile telephone such as by pressing the button 28, which sends a control signal to the control circuit 60. Those having ordinary skill in the art will appreciate, however, that the camera circuitry 48 may be activated by some other means without departing from the scope of the present invention. The method proceeds to step 106 in which the control circuit 60 sends an electrical current to the visual indication element 40, which causes the state of the visual indication element to change from substantially opaque and/or concealed to substantially transparent. Optionally, at step 108, one or more visual and/or optical signals may be output to the user in a user sensible format to indicate a change in state of the camera circuitry 48 and/or the mobile telephone 10. At step 110, the user utilizes the camera function and/or camera circuitry for one or more intended purposes (e.g., taking one or pictures and/or video clips, etc.). At step 112, the camera circuitry is turned to an “off” state. The “off” state may be achieved by any desirable manner. For example, the control circuit 60 may determine that it has not received an input from the user for a predetermined amount time, the user may press button 28 to turn the camera circuitry to an “off” state, etc. At step 114, the control circuit 60 sends a low level signal and/or other suitable control signal to the visual indication element 40 to transform the state of the element 40 from the substantially transparent state to a substantially opaque state and/or concealed state. Optionally at step 116, one or more visual and/or optical signals may be output to the user to indicate a change in state of the camera circuitry.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. An electronic device, comprising:
a microcontroller;
camera circuitry for carrying out a camera related operation operatively coupled to the microcontroller;
a camera lens operatively coupled to the camera circuitry for focusing the camera lens; and
a visual indicator element that covers at least a portion of the camera lens, wherein the visual indicator element is substantially opaque when the camera circuitry is in a first state and the visual indicator element is substantially transparent when the camera circuitry is in a second state.

2. The electronic device of claim 1, wherein the visual indicator element is operatively coupled to the camera circuitry and/or the microcontroller.

3. The electronic device of claim 2, wherein the visual indicator element is in the first state when a first electrical current is applied to the visual indicator element.

4. The electronic device of claim 3, wherein the visual indicator element is in the second state when a second electrical current is applied to the visual indicator element.

5. The electronic device of claim 1 further including an operator input operatively coupled to the camera circuitry and/or the microcontroller for changing the camera circuitry from the first state to the second state.

6. The electronic device of claim 5 further including an operator input operatively coupled to at least the camera circuitry for changing the camera from the second state to the first state.

7. The electronic device of claim 5, wherein the first state corresponds to the camera circuitry being in a deactivated state.

8. The electronic device of claim 7, wherein the second state corresponds to s the camera circuitry being in an activated state.

9. The electronic device of claim 1 further including circuitry operatively coupled to the microcontroller for carrying out an operation unrelated to camera operation.

10. The electronic device of claim 9, the operation unrelated to camera operation includes placing and/or receiving a telephone call to and/or from a mobile telecommunication network.

11. The electronic device of claim 1, wherein an audible indication is selectively output from a speaker coupled to the microcontroller when the visual indication element changes from the first state to the second state and/or from the second state to the first state.

12. The electronic device of claim 1, wherein a user indication signal is selectively output from a flash coupled to the microcontroller when the visual indication element changes from the first state to the second state and/or from the second state to the first state.

13. The electronic device of claim 1, wherein a user indication signal is selectively output from a flash coupled to the microcontroller and an audible indication is selectively output from a speaker coupled to the microcontroller when the visible indication element changes from the first state to the second state and/or from the second state to the first state.

14. The electronic device of claim 1 further including a protective layer over at least a portion of the visual indication element.

15. The electronic device of claim 14, wherein the protective layer is substantially transparent.

16. The electronic device of claim 1, wherein the visual indication element is an electrochromic coating applied over the camera lens.

17. An electronic device, comprising:
a microcontroller;
camera circuitry for carrying out a camera related operation operatively coupled to the microcontroller;
a camera lens operatively coupled to the camera circuitry for focusing the camera lens; and
an electrochromic element that covers at least a portion of the camera lens, wherein the electrochromic element is substantially opaque when the camera circuitry is in a first state and the electrochromic element is substantially transparent when the camera circuitry is in a second state.

18. The electronic device of claim 17, wherein an audible indication is selectively output from a speaker coupled to the microcontroller when the electrochromic element changes from the first state to the second state and/or from the second state to the first state.

19. The electronic device of claim 17, wherein a user indication signal is selectively output from a flash coupled to the microcontroller when the electrochromic element changes from the first state to the second state and/or from the second state to the first state.

20. The electronic device of claim 17 further including a substantially transparent protective layer over at least a portion of the electrochromic element.

21. An electronic device, comprising:
a microcontroller;
camera circuitry for carrying out a camera related operation operatively coupled to the microcontroller;
a camera lens operatively coupled to the camera circuitry for focusing the camera lens, wherein the camera lens is mounted on a housing of the electronic device; and
a visual indicator element that covers at least a portion of the camera lens, wherein the visual indicator element substantially conceals the camera lens when the camera circuitry is in a first state and the camera lens is substantially visible when the camera circuitry is in a second state.

22. The electronic device of claim 21, wherein the visual indicator element substantially matches a color of the housing when the camera circuitry is in the first state.
